(19) United States
(12) Patent Application Publication
(10) Pub. No.: US 2026/0278913 A1
(43) Pub. Date: Sep. 17, 2026

(54) TECHNIQUES FOR BUILDING BVH WITH ORIENTED BOUNDING BOXES

(71) Applicant: Advanced Micro Devices, Inc., Santa Clara, CA (US)

(72) Inventor: Leo Hendrik Reyes Lozano, Santa Clara, CA (US)

(73) Assignee: Advanced Micro Devices, Inc., Santa Clara, CA (US)

(21) Appl. No.: 19/078,667

(22) Filed: Mar. 13, 2025

(51) Int. Cl. G06T 15/06; G06T 15/00; G06T 19/20

(52) U.S. Cl. CPC G06T 15/06; G06T 15/005; G06T 19/20; G06T 2210/12; G06T 2210/21; G06T 2219/2004

(57) ABSTRACT

This disclosure describes techniques for generating oriented bounding boxes within a bounding volume hierarchy. Use of OBBs speeds up ray tracing by reducing false positive hits. However, computing the orientation for each box is typically a complex process. According to this disclosure, a BVH builder generates a BVH having oriented bounding boxes by generating bounding boxes and determining an orientation for one or more such bounding boxes. To generate the orientation for a particular node having a bounding box, the BVH builder selects the orientation of one of the children of the node and uses that orientation as the orientation for the node. This selection is performed without consideration of any other child. Rather than attempting to find the child with the “best” orientation, or finding an orientation that accounts for the orientation of each child, the BVH builder considers the orientation of only one child, which is computationally cheaper.

### BACKGROUND

In ray tracing, a bounding volume hierarchy (BVH) is used to narrow the candidate primitives for performing an intersection test. Box nodes specify bounding boxes that bound underlying geometry. A failed test against the box node eliminates all children from consideration.

Some BVH structures are comprised of axis-aligned bounding boxes (AABBs) which are aligned with the coordinate axes of a 2D or 3D space. Another type of box node is an oriented bounding box (OBB), that can have rotation with respect to the coordinate axes. Ray tracing performance can be enhanced by using a BVH with OBBs as opposed to AABBs. However, building a BVH to include OBBs is more computationally expensive than exclusively using AABBs. This disclosure addresses the computational costs associated with building BVHs that include OBBs.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 illustrates a ray tracing pipeline for rendering graphics using a ray tracing technique, according to an example;

FIG. 4 illustrates a bounding volume hierarchy (“BVH”) according to an example;

FIG. 5 illustrates an example oriented bounding box;

FIG. 6 illustrates a BVH for which orientations are to be determined, according to an example;

FIG. 7 illustrates example primitive ranges;

FIG. 8 illustrates selection of an orientation for a bounding volume;

FIG. 9 illustrates determining an orientation for a triangle; and

FIG. 10 illustrates a method for determining one or more orientations for bounding boxes of a BVH.

### DETAILED DESCRIPTION

This disclosure describes techniques for generating OBBs within a bounding volume hierarchy with improved computational efficiency. Use of OBBs speeds up ray tracing by allowing for orientations other than axis-aligned orientations for bounding volumes. For example, use of such relaxed types of bounding volumes permits the use of tighter boxes around a given geometry, and these tighter boxes in turn speed up ray tracing by preventing “false positive” intersections with bounding volumes. However, computing the orientation for each box node is generally a complex and time-consuming process. The techniques described herein simplify this time-consuming process. As described more fully below, these techniques determine orientations for nodes of a BVH in a manner that is computationally cheap.

In general, a BVH builder generates a BVH having oriented bounding boxes by generating bounding boxes and determining an orientation for one or more such bounding boxes. This disclosure teaches that, to generate the orientation for a particular node having a bounding box, the BVH builder selects the orientation of one of the children of the node and uses that orientation as the orientation for the bounding box of the node. For a leaf node that contains multiple triangles (or other primitives), the “children” are the primitives of the node. The BVH builder selects an orientation of one of the triangles and uses that as the orientation for the bounding volume of the leaf node.

The technique above is computationally cheap because the BVH builder does not perform a comparison between orientations of children. For the leaf node, the BVH builder selects one of the triangles, obtains the orientation for that triangle, and sets the orientation of the leaf node as the orientation for that triangle. In some examples, the BVH builder does not obtain or even generate orientations for any other triangle. Because a comparison between orientations is not performed, the computation involved with this technique is not complex.

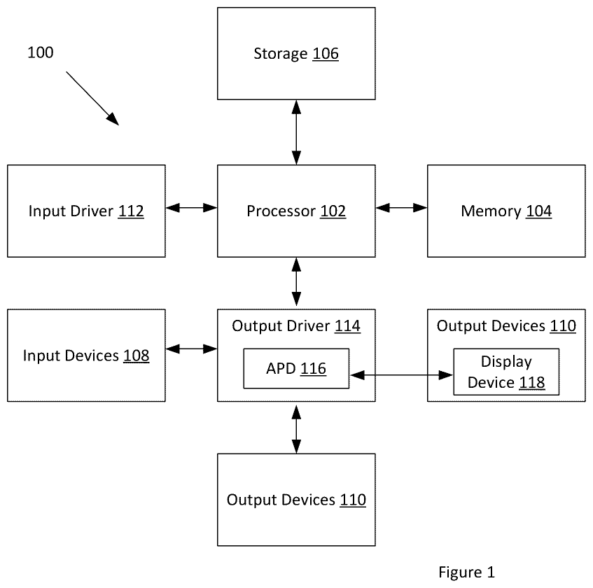

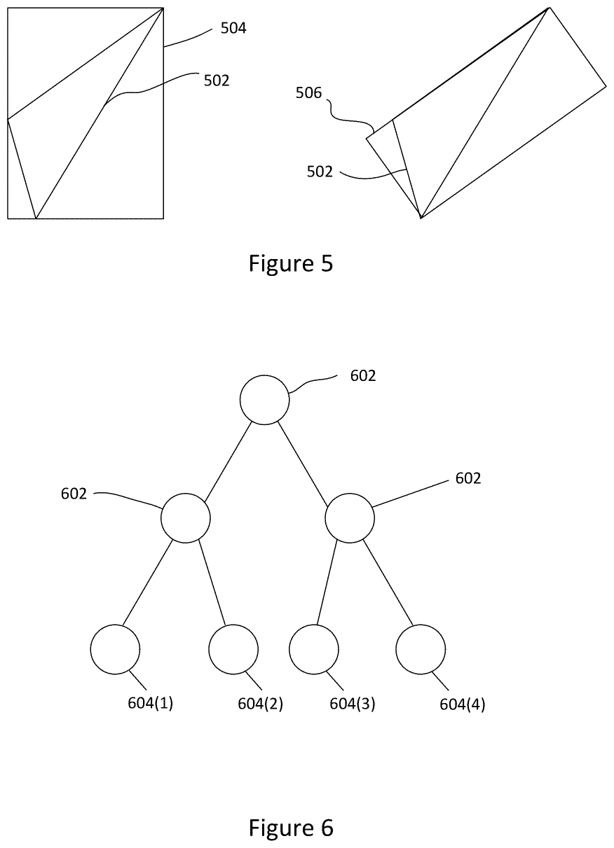

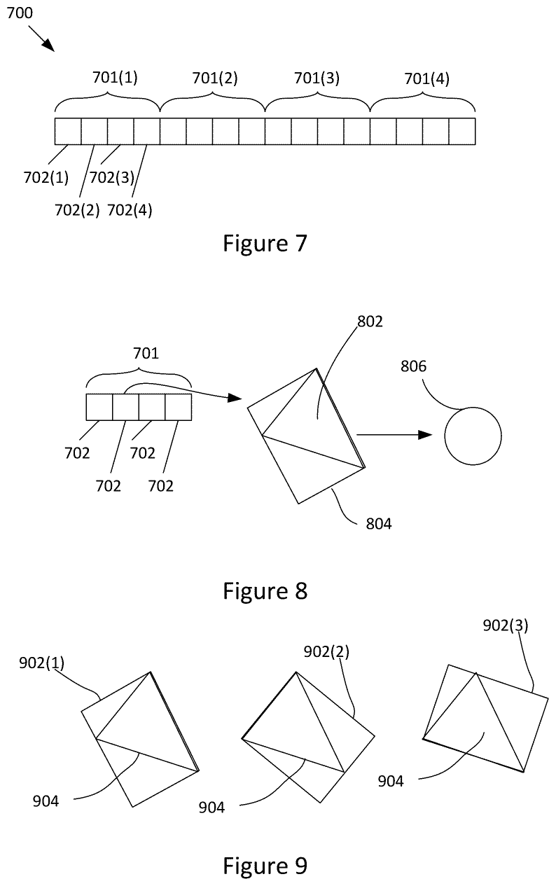

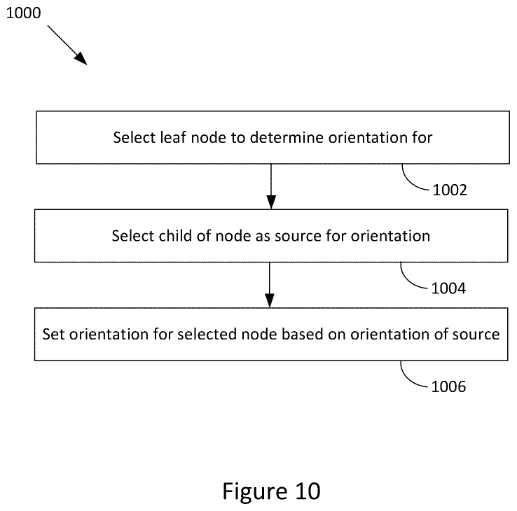

In the present disclosure, FIGS. 1-4 provide background for ray tracing. FIG. 5 illustrates oriented bounding boxes. FIG. 6 illustrates a BVH for which orientations for oriented bounding boxes are determined. FIG. 7 illustrates primitive ranges. FIG. 8 illustrates a technique for setting an orientation for an oriented bounding box. FIG. 9 illustrates a technique for determining an orientation for a triangle. FIG. 10 illustrates a technique for generating a BVH with oriented bounding volumes.

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein.

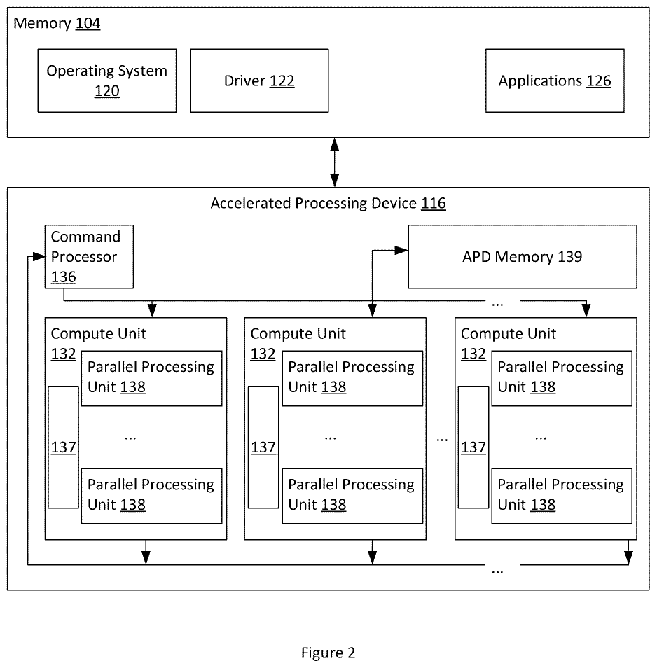

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A command processor 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution. An APD memory 139 serves as memory for the APD 116. Each compute unit 132 includes a local memory (e.g., “local data share”) 137 available to a corresponding compute unit 132 (e.g., the compute unit 132 in which the local memory 137 is within).

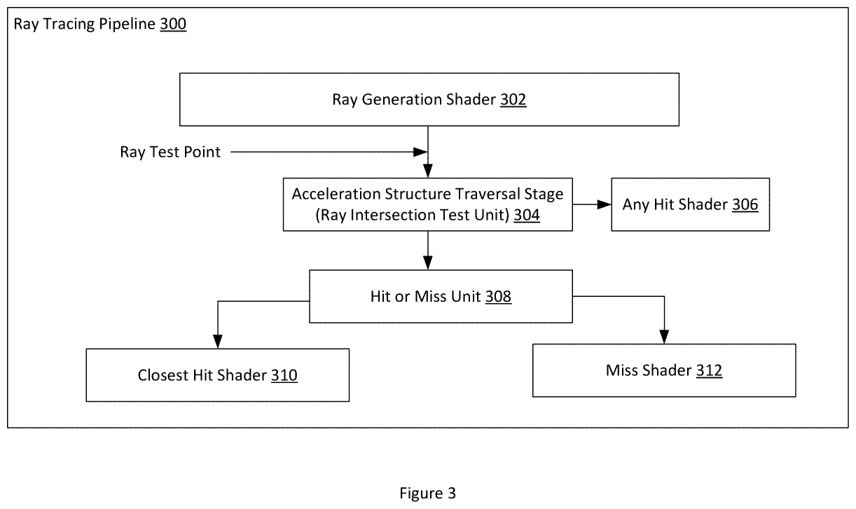

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the command processor 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents a bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against the bounding boxes, followed by tests against triangles.

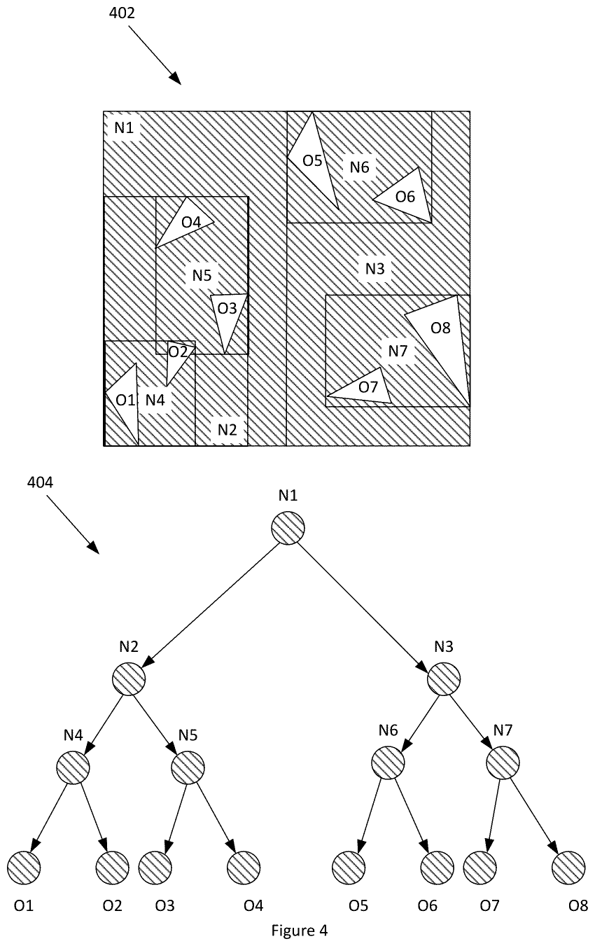

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

As described above, non-leaf nodes (e.g., nodes labeled “N”) of a bounding volume hierarchy include a bounding volume that bounds the contents of the descendants of that non-leaf node (which are called “underlying geometry”). A simple implementation uses axis-aligned bounding boxes as these bounding volumes, where the faces of such bounding boxes are parallel with the axes (e.g., x, y, and z) of the coordinate space. However, it is advantageous to use oriented bounding boxes, which are bounding boxes having faces that are not necessarily aligned with the axes.

FIG. 5 illustrates an example oriented bounding box. More specifically, FIG. 5 illustrates a comparison between an axis-aligned bounding box 504 and an oriented bounding box 506, both of which bound example underlying geometry of one triangle 502. With the axis-aligned bounding box 504, that bounding box bounds the triangle 502, but has a considerable amount of empty space (the space outside of the triangle 502 but within the box 504). This empty space can be considered inefficient, because rays that intersect the box within that empty space will cause the ray tracing pipeline 300 to further traverse the descendants of the associated non-leaf node, but will ultimately result in no intersection for any such descendant. An intersection with a bounding box that does not intersect any underlying geometry is sometimes referred to herein as a “false positive.” Because the role of a non-leaf node is to eliminate geometry from consideration as early as possible, bounding volumes with a considerable amount of empty space are considered inefficient. By orienting bounding boxes, as shown with oriented bounding box 506, the bounding volumes can be made to more tightly fit the underlying geometry, resulting in fewer false positives and thus more efficient operation. In various examples, a bounding volume hierarchy includes oriented bounding boxes as appropriate to reduce the false positives that would occur with exclusive use of axis-aligned bounding boxes during ray tracing.

While oriented bounding boxes provide benefits during BVH traversal, building BVHs with oriented bounding boxes can be computationally expensive. In a simple technique, to determine the orientation for a particular oriented bounding volume, a BVH builder performs an exhaustive search, trying out many different orientations and selecting the orientation producing the best performance. Performance here can be measured using any technically feasible metric, but one common metric is minimal total surface area. Total surface area is the sum of the areas of each side of a box. In this example, the BVH builder calculates the total surface area for the bounding volume corresponding to each orientation and selects the one having the minimal surface area. While this produces good results, it is very time consuming, as multiple surface area calculations must be done per BVH node that is to be made oriented. For this reason, a different technique is provided herein for determining orientation for nodes of a BVH.

FIG. 6 illustrates a BVH 600 for which oriented bounding volumes are being determined. The BVH 600 includes non-leaf nodes 602 and leaf nodes 604. Determining the orientation for nodes of the BVH 600 includes at least determining the orientation for one or more leaf nodes 604. In some examples, each leaf node 604 includes a plurality of triangles, and the orientation for the leaf node 604 applies to each such triangle.

Herein, operations for building a BVH are described as being performed by a BVH builder. A BVH builder is one or more of software executing on a processor (e.g., processor 102 or APD 116), hardware such as fixed function digital circuitry, or a combination thereof. In some examples, the BVH builder is embodied as an APD driver executing on the processor. In some examples, the BVH builder includes software executing on the APD, such as shader programs. A statement that a BVH builder performs an operation herein should be intended to mean that the portion of the processor implementing the BVH, including as programmed by software, performs that operation.

FIG. 7 illustrates a sorted set 700 of primitives 702. In addition, several primitive ranges 701 are illustrated. Each primitive range 701 corresponds to a leaf node 604 in a BVH. In other words, some leaf nodes 604 include multiple primitives 702.

In some examples, a BVH builder generates these primitive ranges 701 from input primitives. More specifically, the BVH builder receives a set of primitives to render from, for example, an application executing on the processor 102. The BVH builder sorts these primitives and then divides the sorted primitives to generate the primitive ranges 701. In some examples, the sorting is according to a z-order curve (e.g., Morton order). A z-order curve converts coordinates into a single scalar value. This is done by interleaving the bits of the different axis values in a set of coordinates. In an example, a Morton code is generated from an x position, a y position, and a z position by placing the following bits in order in the Morton code: the most significant bit (“MSB”) of the x position, the MSB of the y position, the MSB of the z position, the second-most significant bit of the x position, the second-most significant bit of the y position, the second-most significant bit of the z position, and so on. Not all bits of the positions need to be used. This results in a scalar value that has contributions from each axis. In an example, for any given triangle, the position of the centroid of that triangle is obtained and a Morton code is generated for that position. Then, the triangles are sorted by centroid Morton code to obtain the sorted set 700 of primitives 702. This sorted set 700 is a starting point for BVH generation.

In some examples, the BVH builder groups the primitives 702 into primitive ranges 701. The primitive ranges 701 are collections in the sorted order of primitives 702. Each primitive range 701 corresponds to a leaf node in the resulting BVH. In some examples, as one proceeds to non-leaf nodes higher in the hierarchy of the BVH, more primitives ranges are included in such non-leaf nodes. In an example, a non-leaf node that is a parent of two leaf nodes includes two primitive ranges 701. A non-leaf node that is a parent of that non-leaf node and another non-leaf node that is the parent of two leaf nodes includes four primitive ranges 701, and so on. In summary, the primitive ranges 701 are collections of primitives 702 sorted in some order such as z-curve order, that correspond to a leaf node in a resulting BVH. In some examples, the primitives are grouped together (e.g., to form quads) and these groups are sorted. Some examples use spatial metrics to sort triangles in addition to the z-curve, so that primitives in a range share common features.

As stated above, when building a BVH, the BVH builder selects one orientation for a leaf node. More particularly, each leaf node has a bounding volume. During traversal of the BVH, the acceleration structure traversal stage 304 tests the ray for intersection with this bounding volume and eliminates from consideration the one or more triangles of the leaf node if the ray does not intersect that bounding volume. This volume can be oriented rather than axis-aligned, but because there is a single bounding volume that bounds all triangles of the leaf node, there is only one orientation for all of the triangles of the leaf node.

An “ideal” technique for determining the orientation for a bounding volume of a multi-triangle leaf node would be to determine the orientation that has the “optimal” value for a particular metric. In one example, the metric is the total surface area and the optimal value is the lowest total surface area. In this example, the orientation that results in the bounding volume with that orientation having the lowest total surface area, out of all possible orientations, is selected. However, this technique is very computationally expensive, as many different possibilities must be calculated. An alternative technique is therefore provided herein.

FIG. 8 illustrates a technique for determining an orientation for an oriented bounding volume, according to an example. As shown in FIG. 8, a particular primitive range 701 is shown. This primitive range 701 corresponds to a node 806 for which the orientation is being determined. To determine this orientation, the BVH builder selects one triangle 702 of the primitive range 701 and determines an orientation for that triangle 702 (for example, by using a technique such as that shown in FIG. 9). This orientation is the orientation of a bounding volume 804 that tightly bounds the geometry 802 of the selected triangle 702. In some examples, this bounding volume has two faces that are parallel to the surface of the triangle geometry 802 (when the phrase “a face is parallel to a surface” or a similar phrase is used herein, this should be taken to mean that the face and the surface are at least as parallel as possible, given the precision of the numerical representation used for the orientation and triangle geometry 802, accounting for effects such as floating point error). Then, this orientation is used as the orientation for the leaf node 806 corresponding to the primitive range 701.

Stated differently, the orientation corresponding to just one of the triangles 702 of primitive range 701 is used as the orientation for the bounding volume corresponding to the primitive range 701 that includes that triangle. In some examples, this orientation is selected without calculation of an orientation for any of the other triangles. The idea is that the orientation for any of the triangles of a primitive range 701 for a leaf node 806 will be acceptable for all other triangles of that primitive range 701. This means that the BVH builder does not calculate or in any way determine an orientation specific to any other triangle of the primitive range 701. Instead, the BVH builder selects just one of the triangles, determines an orientation for the geometry 802 of that triangle 702, and sets the orientation for the corresponding leaf node 806 to be that determined orientation.

The orientation for one of the triangles of a primitive range 701 is generally acceptable for use as an orientation for the leaf node 806 because the triangles in a primitive range 701 generally share common features. For example, if the primitives in a primitive range 701 are close together in Morton order, then these primitives are likely to be part of the same mesh and to be close together within that mesh, and such primitives are likely to share a similar orientation. For example, such primitives may form part of a larger object and thus may fall on a face of that object. If such a face is completely flat, then the orientation of a triangle on that face will be the same as other triangles on that face. In other examples, triangles that form part of a curve have similar, though not identical orientations, and triangles that span across different flat edges still share some degree of similarity in their orientations. For meshes whose triangles have a random assortment of orientations, no orientation will be particularly suitable for all such triangles, so selection of the orientation for one of the triangles is considered satisfactory for the whole range.

In summary, when building the BVH, the BVH builder generates a leaf node for each primitive range 701. Each such leaf node has a bounding volume that permits elimination from consideration of the triangles 702 of the leaf node if the ray does not hit that bounding volume during traversal. For each such leaf node that will have an oriented bounding volume, the BVH builder selects one triangle of the primitive range 701 for that leaf node, and determines an orientation for that triangle. The BVH builder does not determine an orientation for any other triangle of the primitive range 701 for the purpose of determining the orientation for the leaf node. In particular, the BVH builder does not determine an orientation for any other such triangle for the purpose of performing a comparison of different orientations to determine which is “best.” The BVH builder performs no such evaluation for any other triangle of the primitive range 701 and instead simply selects one of the triangles for the purpose of determining an orientation. The BVH builder sets the orientation for the bounding volume of the leaf node to be the orientation of the selected triangle.

FIG. 9 illustrates example operations for determining an orientation for a triangle. In this example, the BVH builder selects from one of three candidate orientations for the triangle 904. The orientation for each bounding volume 902 is as follows. The bounding volume 902 is oriented to have two faces parallel to the surface of the triangle 904. Then, at least one other surface is parallel to one edge of the triangle 904. Bounding box 902(1) is parallel to the top-right edge of the triangle 904, bounding box 902(2) is parallel to the top-left edge of the triangle 904, and bounding box 902(3) is parallel to the bottom-left edge of the triangle 904. The BVH builder selects one of these candidate orientations based on a selection criterion. In an example, the selection criterion is the smallest total surface area (where “total surface area” means the sum of the areas of each face of the bounding volume). The BVH builder selects the orientation that meets this selection criterion. In the example illustrated, the orientation for the bounding volume 902(2) results in the lowest total surface area, and thus the BVH builder selects that orientation for the triangle 904.

In some examples, the BVH builder determines the orientation for just one triangle out of the triangles 702 in a primitive range 701, or for fewer than all of the triangles of such triangles 702. Additionally, although an example technique for selecting an orientation for a bounding volume of such a triangle is shown, any technically feasible technique for selecting such an orientation could be used instead. In particular, in one example, rather than determining three different orientations as in FIG. 9, the BVH builder only determines one of those orientations and uses that orientation as the orientation for the triangle. In another example, the BVH builder determines an orientation whose bounding volume is parallel with the triangle geometry 904 but is not necessarily parallel with any of the edge of the triangle. Any other technically feasible technique for determining the orientation of the bounding volume for a triangle can alternatively be used.

As stated above, to determine the orientation for a leaf node 604, the BVH builder determines an orientation for one of the triangles of the leaf node 604 and uses that orientation as the orientation for the leaf node. In some examples, the BVH builder does not determine the orientation of any other triangle of the leaf node.

There are various ways in which the BVH builder can select a particular triangle of a primitive range 701 from which to generate the orientation. In one example, the BVH builder selects a random or pseudo-random triangle in the primitive range 701. A “random” selection means that the triangle selected is not based on any execution state of the processor—many of the triangles 702 of the primitive range 701 can be selected. A pseudo-random selection means that the selection made is based on execution state of the processor, but in a way that appears to be random. Many example functions for generating pseudo-random numbers exist. In another example, the BVH builder selects a triangle in the same position within the primitive range 701 each time the BVH builder makes a selection. For example, each primitive 702 has a position represented by an index within a primitive range 701. In the example of FIG. 8, the left-most primitive has index 0, the one to the right of that has index 1, the one to the right of that has index 2, and the one to the right of that has index 3. In some examples, these indices indicate the order of the information for the primitive 702 within memory, with lower indices coming before higher ones in memory. In some examples, the BVH builder always selects the primitive 702 having the same index—such as index 0 (the first primitive 702) or the primitive 702 having the highest index.

In some examples, the BVH builder rotates through the indices, selecting a different index each time in a repeating pattern. In an example, the BVH builder is determining the orientation for a first non-leaf node 604 corresponding to a first primitive range 701 and selects the first triangle 702 (e.g., index 0) of that range 701. Then, the BVH builder determines the orientation for a second non-leaf node 604 corresponding to a second primitive range 701 and selects the second triangle (e.g., index 1), and so on. Although a monotonically increasing repeating pattern is described, any pattern could alternatively be used. Any other O(1) (constant time) operation to select a node would work. In another example, the operation N mod M is performed, where N is the current node's index and M is the number of primitives in the leaf. Any hash operation could work as well.

FIG. 10 is a flow diagram of a method 1000 for determining an orientation for a node of a bounding volume hierarchy, according to an example. Although described with respect to the system of FIGS. 1-9, those of skill in the art will understand that any system configured to perform the steps of the method 1000 in any technically feasible order falls within the scope of the present disclosure.

At step 1002, a BVH builder selects a node (a leaf node) to determine an orientation for. In some examples, the BVH from which the node is selected is already fully built and the BVH builder determines orientations for one or more of the nodes. In other examples, the BVH is not fully built. Instead, the BVH builder determines orientations for the leaf nodes of the BVH while building the BVH. Step 1002 can be performed for any leaf node of the BVH.

At step 1004, the BVH builder selects a child of the selected node as a source for an orientation for the selected node. More specifically, the child is one of the primitives 702 of the leaf node 604 (e.g., of the primitive range 701). The BVH builder selects such a child in any technically feasible manner such as using one of the techniques described herein above. In various examples, the BVH builder selects the first child, the last child, the child in the same position, a random or pseudo-random child, or according to a repeating pattern.

At step 1006, the BVH builder sets the orientation for the selected node based on the orientation of the source. More specifically, the child is a triangle, and the BVH builder determines the orientation for the triangle in any technically feasible manner. In some examples, the BVH builder uses the technique of FIG. 9 to determine the orientation of the triangle. This orientation is used as the orientation for the leaf node.

The technique of FIG. 10 can be used any number of times while building a BVH to generate orientations for any or all of the leaf nodes of that BVH.

As described elsewhere herein, once generated, the BVH with oriented nodes would be traversed for rays during ray tracing. More specifically, the ray tracing pipeline 300 uses such a BVH as described herein, such as to eliminate nodes from consideration and to determine what shading work to perform. More specifically, when a ray is generated for ray tracing, the ray tracing pipeline 300 traverses the BVH for such a ray. The ray tracing pipeline 300 eliminates nodes from consideration if an ancestor of such nodes is not intersected by the ray. The intersection test can be performed for nodes having an oriented bounding box, and simply involves testing the ray for intersection with such oriented bounding box. Prior to performing such operations, an entity such as an application requests another entity such as a driver to build the BVH. In response, the BVH builder builds a BVH including oriented bounding boxes having orientations set based on the teachings provided herein.

Although the term “triangle” is sometimes used herein as an example of a primitive, it should be understood that any primitive geometry could alternatively or additionally be used. Thus, the term “triangle” used herein can be replaced with primitive.

The various functional units illustrated in the figures and/or described herein (including, but not limited to, the processor 102, the accelerated processing device 116, the command processor 136, the compute units 132, the SIMD units 138, ray tracing pipeline 300, ray generation shader 302, acceleration structure traversal stage 304, any hit shader 306, hit or miss unit 308, closest hit shader 310, miss shader 312, or BVH builder may be implemented as a general purpose computer, a processor, or a processor core, or as a program, software, or firmware, stored in a non-transitory computer readable medium or in another medium, executable by a general purpose computer, a processor, or a processor core.

It should be understood that many variations are possible based on the disclosure herein. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method, comprising:
selecting a node of a bounding volume hierarchy (“BVH”);
selecting a child of the node as a source for determining an orientation of the selected node; and
setting the orientation of the selected node based on the source for the orientation.

2. The method of claim 1, wherein the node is a leaf node.

3. The method of claim 2, wherein the child of the node is a triangle.

4. The method of claim 3, wherein setting the orientation of the node based on the source for the orientation comprises determining an orientation for the triangle and setting the orientation of the node as the orientation for the triangle.

5. The method of claim 4, wherein setting the orientation comprises determining the orientation of the triangle without considering an orientation for any other child of the node.

6. The method of claim 1, further comprising setting an orientation for additional nodes of the BVH.

7. The method of claim 1, wherein the setting the orientation is part of a BVH build process to generate a BVH requested by an application.

8. The method of claim 7, wherein the application is configured to request rendering using the BVH.

9. The method of claim 7, wherein the BVH build process first generates axis-aligned bounding boxes for leaf nodes and then determines orientations for the leaf nodes.

10. A system comprising:
a memory configured to store data for a bounding volume hierarchy (“BVH”); and
a processor configured to perform operations comprising:
selecting a node of the BVH;
selecting a child of the node as a source for determining an orientation of the selected node; and
setting the orientation of the selected node based on the source for the orientation.

11. The system of claim 10, wherein the node is a leaf node.

12. The system of claim 11, wherein the child of the node is a triangle.

13. The system of claim 12, wherein setting the orientation of the node based on the source for the orientation comprises determining an orientation for the triangle and setting the orientation of the node as the orientation for the triangle.

14. The system of claim 13, wherein setting the orientation comprises determining the orientation of the triangle without considering an orientation for any other child of the node.

15. The system of claim 10, wherein the operations further comprise setting an orientation for additional nodes of the BVH.

16. The system of claim 10, wherein the setting the orientation is part of a BVH build process to generate a BVH requested by an application.

17. The system of claim 16, wherein the application is configured to request rendering using the BVH.

18. The system of claim 16, wherein the BVH build process first generates axis-aligned bounding boxes for leaf nodes and then determines orientations for the leaf nodes.

19. A non-transitory computer-readable medium storing instructions that, when executed by a processor, cause the processor to perform operations comprising:
selecting a node of a bounding volume hierarchy (“BVH”);
selecting a child of the node as a source for determining an orientation of the selected node; and
setting the orientation of the node based on the source for the orientation.

20. The non-transitory computer-readable medium of claim 19, wherein the node is a leaf node.
